(19) United States
(12) Patent Application Publication
(10) Pub. No.: US 2013/0328306 A1
(43) Pub. Date: Dec. 12, 2013

(54) JOINT MEMBER, JOINT, SUBSTRATE PROCESSING APPARATUS AND LIMIT MEMBER

(71) Applicant: TOKYO ELECTRON LIMITED, Tokyo (JP)

(72) Inventors: Izumi SATO, Oshu-shi (JP); Shusuke KONNO, Oshu-shi (JP); Tomoyuki NAGATA, Nirasaki City (JP)

(21) Appl. No.: 13/911,809

(22) Filed: Jun. 6, 2013

(30) Foreign Application Priority Data
Jun. 7, 2012 (JP) 2012-130202

(51) Int. Cl. F16L 49/06

(52) U.S. Cl. CPC F16L 49/06
USPC 285/386

(57) ABSTRACT

A joint member that includes a cylindrical sleeve member having a first outer diameter portion having a first outer diameter and a second outer diameter portion having a second outer diameter smaller than the first outer diameter. The joint member further includes a cylindrical nut member having an inner peripheral surface on which a first thread is formed and a bottom in which an opening is formed. The joint member further includes a limit member fixed to an outer periphery portion of the second outer diameter portion inserted into the opening and in contact with an outer surface of the bottom of the cylindrical nut member.

### CROSS-REFERENCE TO RELATED APPLICATION

This application claims the benefit of Japanese Patent Application No. 2012-130202, filed on Jun. 7, 2012, in the Japan Patent Office, the disclosure of which is incorporated herein in its entirety by reference.

### TECHNICAL FIELD

The present disclosure relates to a joint member configured to connect pipes, a joint, a substrate processing apparatus having the joint, and a limit member.

### BACKGROUND

In a process of manufacturing a semiconductor integrated circuit (IC), a manufacturing apparatus, such as a heat diffusion furnace or a film forming apparatus is used, which processes a semiconductor substrate (hereinafter, simply referred to as a substrate), such as a silicon wafer, by supplying a predetermined gas to the substrate.

Some of these manufacturing apparatuses include a reaction tube, for example, made of quartz glass and having a circular cylindrical shape with a ceiling, a manifold for supporting a bottom of the reaction tube, and an injector extending in a lengthwise direction of the reaction tube to supply a predetermined gas into the reaction tube. The injector is inserted into and supported by a pipe-shaped injector support installed to an outer wall of the manifold and is simultaneously connected to a gas pipe by a joint installed to a leading end of the injector support. Such a configuration enables predetermined gas to pass through the gas pipe and the injector and to be supplied into the reaction tube.

In the manufacturing apparatus as described above, the manifold and the injector support are made, for example, of metal such as stainless steel or aluminum. The joint at the leading end of the injector support and the gas pipe connected to the leading end of the injector support are also made of metal. Meanwhile, since the injector is heated at high temperature in the reaction tube, the injector is made, for example, of quartz glass when it is preferable for the injector to be made of a material having a high melting temperature and high purity. In this case, the injector made of quartz glass is connected to the gas pipe made of metal by the joint.

Here, referring to FIGS. 1A to 1C, an example of a joint configured to connect an injector made of quartz glass and a gas pipe made of metal will be described. As shown in FIGS. 1A to 1C, a joint member 200 has a sleeve 220 and a nut 240. The sleeve 220 is a pipe-shaped member, into which one end of an injector J is insertable, and has a large diameter portion 220L having a large outer diameter, a medium diameter portion 220M having an outer diameter smaller than that of the large diameter portion 220L, and a small diameter portion 220S having an outer diameter smaller than that of the medium diameter portion 220M. In addition, a gas pipe L made of metal is welded to a leading end of the small diameter portion 220S.

The nut 240 is a cylindrical member having a bottom 240B and has an inner diameter larger than the outer diameter of the large diameter portion 220L of the sleeve 220. In addition, a thread 220N (see FIG. 1C) is formed on an inner peripheral surface of the nut 240, and an opening, into which the medium diameter portion 220M of the sleeve 220 is insertable, is formed in the bottom 240B of the nut 240.

After an O-ring 300, a spacer ring 320, and an O-ring 340 are installed around the injector J protruding from a leading end of an injector support 140A, if the nut 240, into which the medium diameter portion 220M and the small diameter portion 220S of the sleeve 220 are inserted, is twisted onto a thread formed on the leading end of the injector support 140A, the large diameter portion 220L of the sleeve 220 moves toward a leading end of the injector J and the leading end of the injector J is inserted into the sleeve 220. If the nut 240 is further twisted onto the thread, the large diameter portion 220L of the sleeve 220 presses the O-ring 340 and the O-ring 340 presses the spacer ring 320, and thereby the spacer ring 320 pressing the O-ring 300. Accordingly, the O-ring 340 is brought into a strongly close contact with an end surface of the large diameter portion 220L of the sleeve 220 and an outer peripheral surface of the injector J, so that interiors of the sleeve 220 and the injector J are air-tightly sealed from the outside.

However, for example, in the maintenance of a manufacturing apparatus, the nut 240, the sleeve 220 and the gas pipe L are removed from the manufacturing apparatus by disconnecting the nut 240 of the joint member 200 from the injector support 140A. Here, the following problems may occur. As shown in FIG. 1B, as the nut 240 becomes loosened, the nut 240 moves away from the leading end of the injector J. In this case, the sleeve 220 does not move together with the nut 240, and in some cases, the large diameter portion 220L of the sleeve 220 stays in a position in which it presses the O-ring 340 (a position shown in FIG. 1B). This may occur, for example, because the O-ring 340 is stuck to the outer peripheral surface of the injector J and the end surface of the large diameter portion 220L of the sleeve 220. Here, if the nut 240 becomes further loosened, the self-weight of the gas pipe L or the like, for example, causes a force exerted on the sleeve 220 to be tilted with respect to the injector J. As shown in FIG. 1C, if the sleeve 220 is tilted with respect to the injector J, the sleeve 220 may cause the leading end of the injector J made of quartz glass to be torn or cracked.

In addition, not only when the gas pipe L is removed, but also when the gas pipe L is installed, for example after maintenance, since the sleeve 220 is tilted with respect to the injector J or locally struck against the injector, the leading end of the injector J may be torn or cracked. In such a case, particles of quartz are generated, and the particles are transferred together with the supply gas into a reaction tube of the manufacturing apparatus, thus wafers contained in the reaction tube are contaminated.

### SUMMARY

In view of the forgoing, the present disclosure provides a joint member, a joint, a substrate processing apparatus, and a limiting member preventing a leading end of an injector from being torn or cracked.

According to a first aspect of the present disclosure, provided is a joint member comprising a cylindrical sleeve member having a first outer diameter portion having a first outer diameter and a second outer diameter portion having a second outer diameter smaller than the first outer diameter, both the first and the second outer diameter portions arranged along an central axis; a cylindrical nut member having an inner peripheral surface on which a first thread is formed and a bottom in which an opening is formed, an inner diameter of the inner peripheral surface is larger than the first outer diameter, and a diameter of the opening is smaller than the first outer diameter and larger than the second outer diameter; and a limit member fixed to an outer periphery portion of the second outer diameter portion inserted into the opening and in contact with an outer surface of the bottom of the cylindrical nut member, and the first outer diameter portion is contacted with an inner surface of the bottom of the cylindrical nut member, the limit member limiting movement of the cylindrical sleeve member relative to the cylindrical nut member in the direction of the central axis.

According to a second aspect of the present disclosure, provided is a joint comprising the joint member according to the first aspect; and a circular cylindrical male screw portion having an outer peripheral surface on a leading end of which a fourth thread corresponding to the first thread is formed.

According to a third aspect of the present disclosure, provided is a substrate processing apparatus, comprising the joint according to the second aspect; and a chamber made of metal, the circular cylindrical male screw portion being installed to the chamber.

According to a fourth aspect of the present disclosure, provided is a limit member comprising a fixing portion fixed to an outer periphery portion of a second outer diameter portion of a cylindrical sleeve member which is inserted into an opening formed in a bottom of a cylindrical nut member. The cylindrical sleeve member has a first outer diameter portion having a first outer diameter and the second outer diameter portion having a second outer diameter smaller than the first outer diameter, the first and second outer diameter portions arranged along the central axis and a through-hole formed along the central axis in the first and second outer diameter portions. Also, the cylindrical nut member has an inner peripheral surface on which a first thread is formed and a bottom in which an opening is formed, an inner diameter of the inner peripheral surface larger than the first outer diameter, and a diameter of the opening smaller than the first outer diameter and larger than the second outer diameter. Thus, when the cylindrical sleeve member is inserted into the opening formed in the bottom of the cylindrical nut member, the limit member is in contact with an outer surface of the bottom of the cylindrical nut member, and the first outer diameter portion is contacted with an inner surface of the bottom of the cylindrical nut member, the limit member limiting movement of the cylindrical sleeve member relative to the cylindrical nut member in a direction of an central axis.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIGS. 1A to 1C are schematic views illustrating a conventional joint.

FIG. 2 is a partial sectional view illustrating a substrate processing apparatus in which a joint according to an embodiment of the present disclosure is appropriately used.

FIGS. 3A and 3B are views illustrating a joint member according to an embodiment of the present disclosure.

FIGS. 4A to 4D are views illustrating usage of the joint member according to the embodiment of the present disclosure.

FIGS. 5A to 5C are views illustrating an effect (or advantage) caused by the joint member according to the embodiment of the present disclosure.

FIGS. 6A and 6B are schematic views showing a modification of the joint member (or limit member) according to the embodiment of the present disclosure.

### DETAILED DESCRIPTION

Hereinafter, non-limiting, exemplary embodiments of the present disclosure will be described with reference to the accompanying drawings. In the drawings, the same or corresponding reference numerals are given to the same or corresponding members or components, and redundant descriptions thereof will be omitted. It is to be noted that the drawings has no intention to indicate relative proportions among the members or components. Therefore, the specific size should be determined by a person having ordinary skill in the art in view of the following non-limiting embodiments

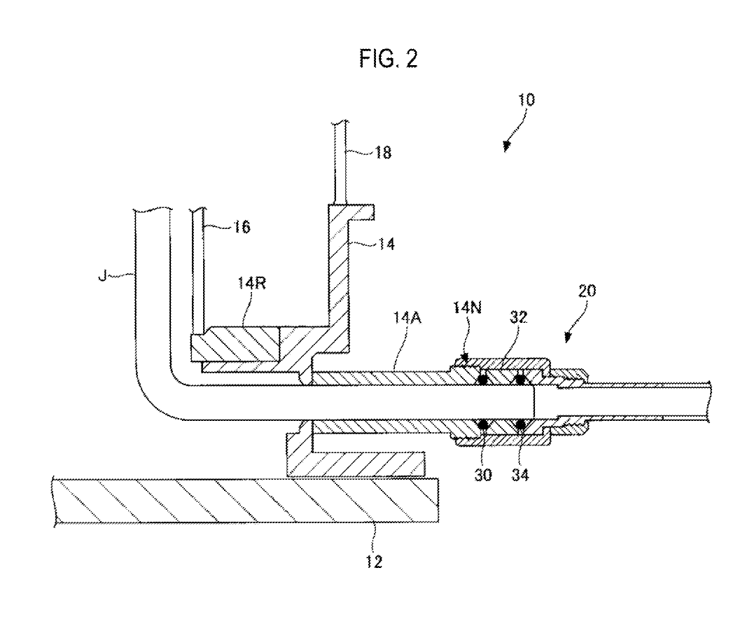

Referring to FIG. 2, a substrate processing apparatus provided with a joint according to an embodiment of the present disclosure will be described. FIG. 2 is a partial sectional view illustrating the substrate processing apparatus. As shown in FIG. 2, a substrate processing apparatus 10 has a circular cylindrical shape, and is provided with a manifold 14 air-tightly mounted onto a base portion 12, an inner tube 16 supported by the manifold 14 through an annular member 14R and having a circular cylindrical shape with a ceiling, and an outer tube 18 air-tightly supported to the manifold 14 by the manifold 14. The substrate processing apparatus 10 includes a reaction tube (or a chamber) consisted of the inner tube 16 and the outer tube 18, which receives the substrate to be processed.

An outer wall of the manifold 14 having a circular cylindrical shape is provided with an injector support pipe 14A (an injector support), having a circular cylindrical shape and extending on an extension line of a diameter direction of the manifold 14. The injector J made of quartz glass is inserted inside the injector support pipe 14A and a leading end of the injector J protrudes from a leading end of the injector support pipe 14A. The injector J is bent into an L shape within the inner tube 16 to extend upward along an inner peripheral surface of the inner tube 16. The injector J has a plurality of gas injection holes (not shown), and a predetermined gas is supplied from the gas injection holes to a substrate such as a semiconductor wafer (not shown) accommodated in the inner tube 16. In addition, a thread 14N (a fourth thread) is formed on a leading end of an outer peripheral surface of the injector support pipe 14A, which is a male screw portion, whereby a joint member 20 is installed to the leading end of the injector support pipe 14A.

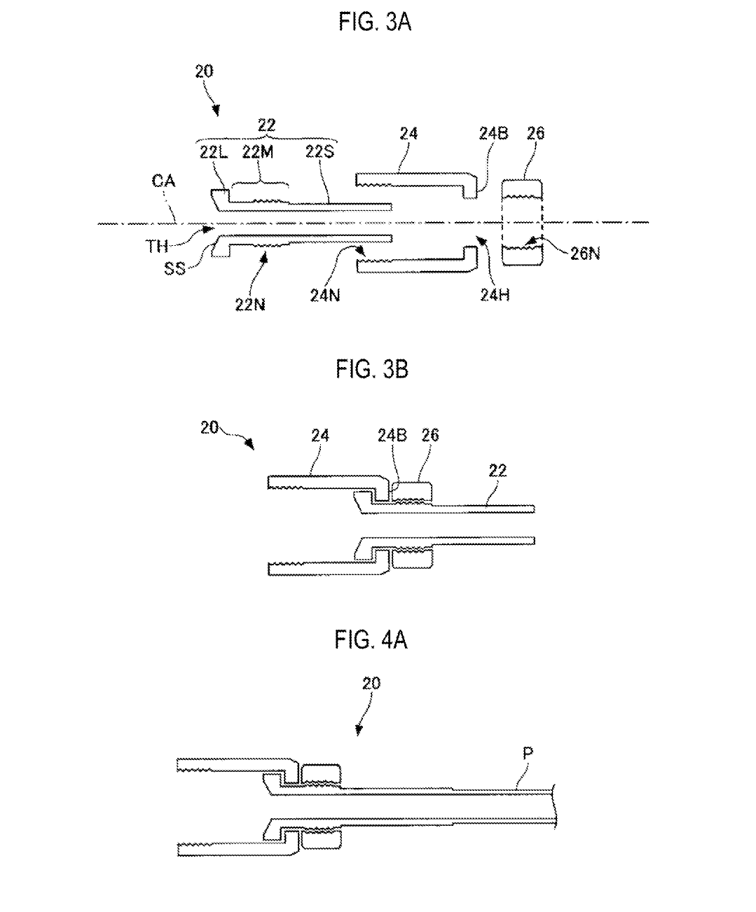

Referring to FIG. 3A, the joint member 20 has a sleeve 22 (a sleeve member), a nut 24 (a nut member) and a support nut 26. The sleeve 22, the nut 24 and the support nut 26 (limit member) may be made, for example, of metal such as stainless steel.

The sleeve 22 has a circular cylindrical shape with a through-hole TH formed along a central axis CA. The through-hole TH has an inner diameter slightly larger than an outer diameter of the injector J shown in FIG. 2. For this reason, the leading end of the injector J may be inserted into the sleeve 22. In addition, the sleeve 22 are provided with a large diameter portion 22L (first outer diameter portion) having a large outer diameter, a medium diameter portion 22M (second outer diameter portion) having an outer diameter smaller than that of the large diameter portion 22L, and a small diameter portion 22S having an outer diameter smaller than that of the medium diameter portion 22M in order. A leading end of the large diameter portion 22L has an inclined end surface SS formed to be inclined from its outer periphery toward its inner periphery. In addition, an outer peripheral surface of the medium diameter portion 22M of the sleeve 22 has a thread 22N (a third thread) formed thereon.

The nut 24 has a circular cylindrical shape with a bottom 24B provided in one end thereof. The bottom 24B has an opening 24H formed therein, and the opening 24H has an inner diameter slightly larger than the outer diameter of the medium diameter portion 22M of the sleeve 22. For this reason, when the sleeve 22 is inserted into the nut 24, the large diameter portion 22L of the sleeve 22 is accommodated inside the nut 24 while the medium diameter portion 22M and the small diameter portion 22S protrude out of the opening 24H of the nut 24. Also, since the inner diameter of the opening 24H is slightly larger than the outer diameter of the medium diameter portion 22M, it is possible to minimize a clearance between the sleeve 22 and the nut 24.

In addition, an inner peripheral surface of the other end of the nut 24 has a thread 24N (a first thread) formed thereon corresponding to the thread 14N shown in FIG. 2, which is formed on the leading end of the injector support pipe 14A. This allows the joint member 20 as well as the nut 24 to be installed to the leading end of the injector support pipe 14A. That is, the nut 24 having the thread 24N formed on the inner peripheral surface thereof is equivalent to a female screw, and the injector support pipe 14A having the thread 14N formed on the leading end thereof functions as a male screw corresponding to the nut 24.

The support nut 26 has a circular cylindrical shape or an annular shape. An inner diameter of the support nut 26 allows the medium diameter portion 22M of the sleeve 22 to be inserted into the support nut 26. Also, the inner peripheral surface of the support nut 26 has a thread 26N (a second thread), that is an example of a fixing portion, formed thereon corresponding to the thread 22N formed on the medium diameter portion 22M of the sleeve 22. The support nut 26 is installed to the sleeve 22 by twisting the support nut 26 onto the medium diameter portion 22M of the sleeve 22.

The medium diameter portion 22M and the small diameter portion 22S of the sleeve 22 are inserted from the inside of the nut 24 to pass through the opening 24H of the nut 24. The medium diameter portion 22M and the small diameter portion 22S are allowed to protrude from the nut 24. Then, the support nut 26 is installed around the small diameter portion 22S, and the support nut 26 is twisted onto the medium diameter portion 22M, thereby constituting the joint member 20 shown in FIG. 3B.

Here, a slight gap is formed between the support nut 26 and an outer surface of the bottom 24B of the nut 24. Thus, the nut 24 can rotate without being obstructed by the support nut 26. In addition, when the support nut 26 is installed to the sleeve 22, the large diameter portion 22L of the sleeve 22 accommodated in the nut 24 has a slight gap but can be in contact with an inner surface of the bottom 24B of the nut 24. That is, the large diameter portion 22L contacts with the inner surface of the bottom 24B of the nut 24, and the support nut 26 installed to the medium diameter portion 22M of the sleeve 22 contacts with the outer surface of the bottom 24B of the nut 24. Therefore, the movement of the sleeve 22 relative to the nut 24 can be limited.

Next, a sequence of connecting the injector J and a predetermined pipe P by installing the joint member 20 to the injector support pipe 14A will be described.

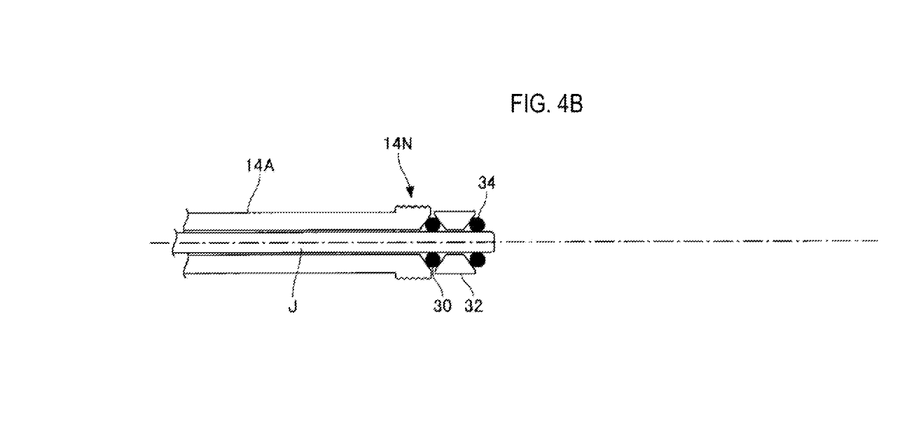

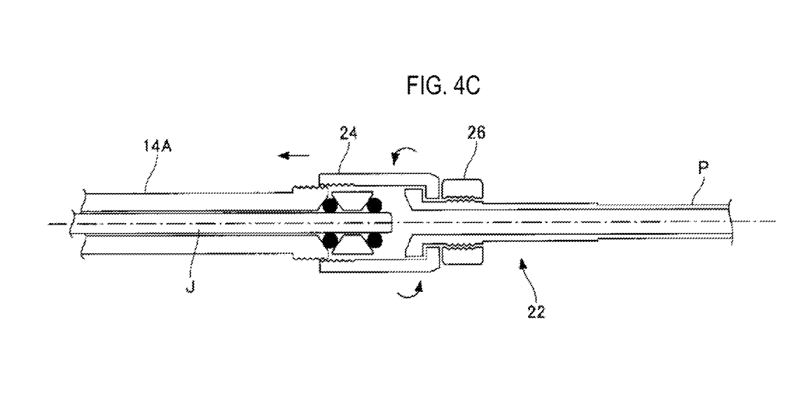

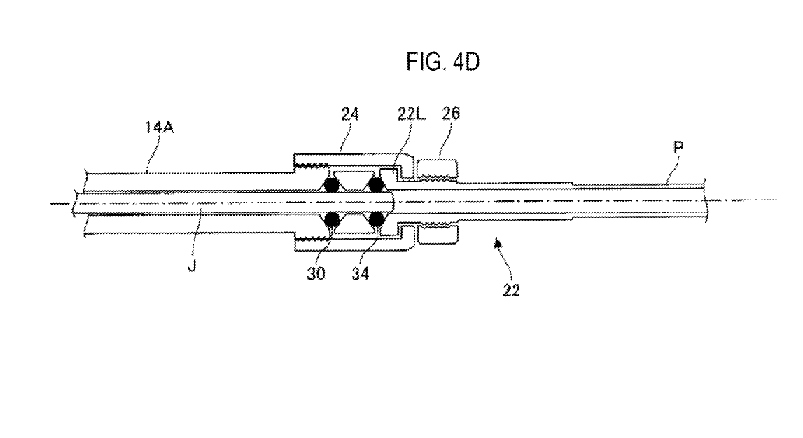

First, the predetermined pipe P is welded to a leading end of the small diameter portion 22S of the joint member 20 shown in FIG. 3B (FIG. 4A). The pipe P is connected, for example, to a supply source (not shown) of process gas used in the substrate processing apparatus 10 (FIG. 2). In addition, the pipe P may be provided, for example, with an opening/closing valve or a flow rate controller, thereby supplying the substrate processing apparatus 10 with a process gas at a predetermined flow rate.

Next, the injector J is inserted into the injector support pipe 14A from the inside of the manifold 14 shown in FIG. 2. Thereafter, as shown in FIG. 4B, an O-ring 30, a spacer ring 32, and an O-ring 34 are installed to a portion of the injector J which protrudes from the leading end of the injector support pipe 14A. Here, the spacer ring 32 has an annular shape, and each of both leading ends thereof has an inclined end surface formed to be inclined from its outer periphery toward its inner periphery.

Thereafter, as shown in FIG. 4C, if the nut 24 is twisted onto the leading end of the injector support pipe 14A, the large diameter portion 22L of the sleeve 22 is pressed by the inner surface of the bottom 24B of the nut 24, and thus, the sleeve 22 also moves toward the injector J.

As shown in FIG. 4D, when the nut 24 is securely tightened, the leading end of the injector J is slightly inserted into the sleeve 22, and at the same time, the O-ring 34 is pressed onto an outer peripheral surface of the injector J by the inclined end surface of the large diameter portion 22L of the sleeve 22 and the inclined end surface of the spacer ring 32. For this reason, the O-ring 34 is in close contact with the three positions: the two inclined end surfaces and the outer peripheral surface of the injector J, whereby an inner space of the injector J and pipe P is isolated from an outer space thereof. In addition, the O-ring 30 is pressed onto an inclined end surface of the injector support pipe 14A, the inclined end surface of the spacer ring 32, and the outer peripheral surface of the injector J, whereby the inner space of the injector J and pipe P are more securely isolated from the outer space thereof.

As such, the inner space of the injector J and the pipe P are isolated from the outer space thereof, and simultaneously, the inner space of the injector J is in communication with the inner space of the pipe P, whereby the injector J and the pipe P are connected to each other.

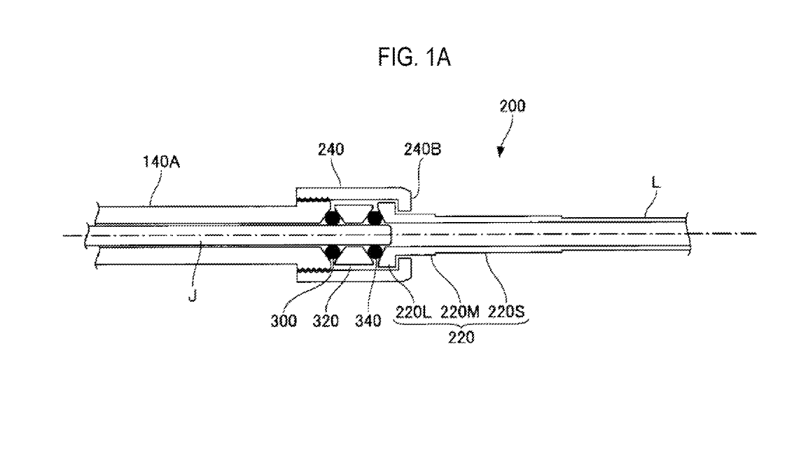

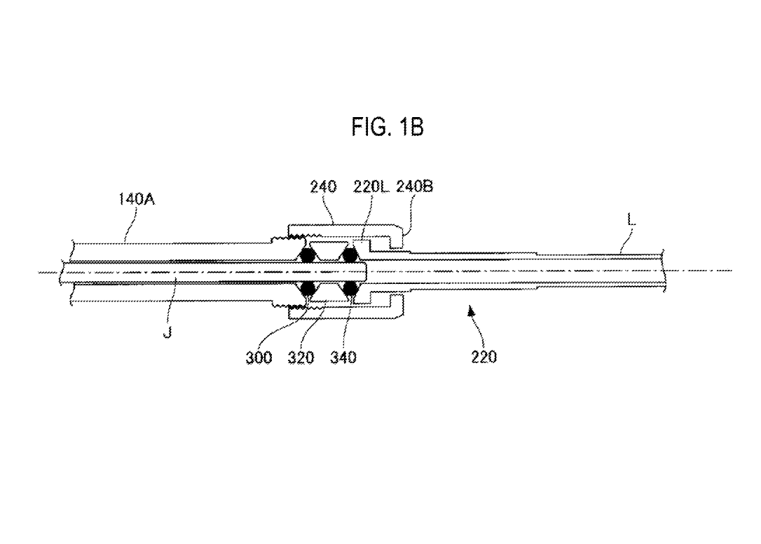

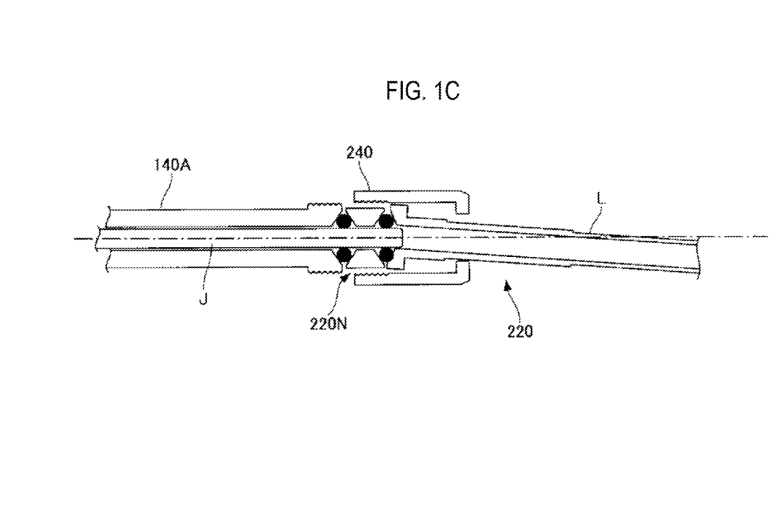

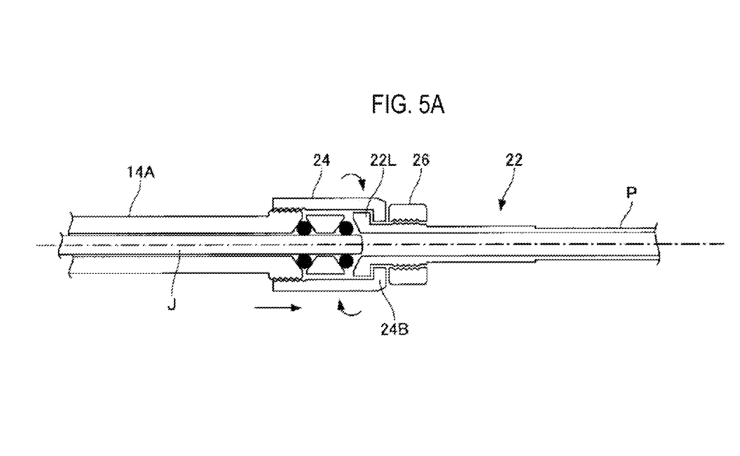

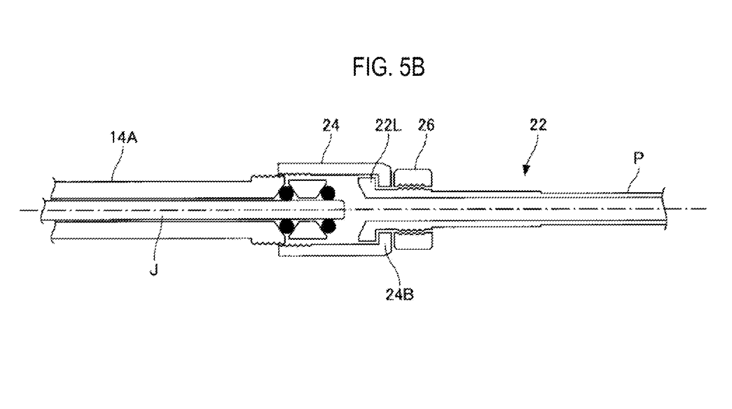

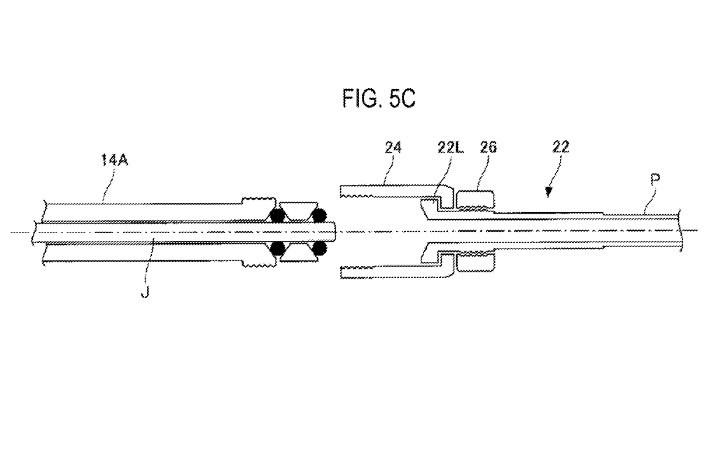

Next, an effect (or an advantage) caused by the joint member 20 according to the embodiment of the present disclosure will be described. When the joint member 20 is disconnected from the injector support pipe 14A, if the nut 24 becomes loosened as shown in FIG. 5A, the nut 24 moves away from the injector support pipe 14A in a direction of the central axis of the injector J. Here, since the support nut 26 installed to the medium diameter portion 22M is pressed by the outer surface of the bottom 24B of the nut 24, the sleeve 22 moves together with the nut 24 in the same direction. Accordingly, the large diameter portion 22L of the sleeve 22 is spaced apart from the leading end of the injector J as shown in FIG. 5B. In addition, since the large diameter portion 22L of the sleeve 22 is close to the inner surface of the bottom 24B of the nut 24 and the movement of the sleeve 22 relative to the nut 24 is limited, which is different from the sleeve 220 shown in FIGS. 1A to 1C, the sleeve 22 is not tilted with respect to the central axis of the injector J. Therefore, the large diameter portion 22L of the sleeve 22 is not locally in contact with and is not struck against the leading end of the injector J, and the leading end of the injector J is prevented from being torn or cracked by the sleeve 22. Therefore, while the sleeve 22 is not tilted, the nut 24 (the joint member 20) is removed from the injector support pipe 14A (FIG. 5C).

In addition, when a flexible tube is connected to the sleeve 220 of FIGS. 1A to 1C, since the flexible tube is pliable, a large force is not applied to the sleeve 220 even though the nut 240 is loosened. Thus, the sleeve 220 is not tilted. However, for example, when a tape heater or the like is wound around the flexible tube for the purpose of preventing the reaction gas in the flexible tube from being condensed, the flexible tube would not pliably bent, a force is applied to the flexible tube due to the tape heater, and may also be applied to the sleeve 220. Thus, the large diameter portion 220L of the sleeve 220 locally contacts with or is struck against the leading end of the injector J, whereby the injector J may be torn or cracked. However, even in this case, according to the joint member 20 of this embodiment, since the sleeve 22 is prevented from being tilted, it is possible to prevent the leading end of the injector J from being torn or cracked.

Also, when the joint member 20 is installed to the injector support pipe 14A, if the nut 24 is twisted onto the leading end of the injector support pipe 14A, since the inner surface of the bottom 24B of the nut 24 is in contact with the large diameter portion 22L to press the sleeve 22, the sleeve 22 may be positioned near the leading end of the injector J. In this case, the support nut 26 installed to the medium diameter portion 22M of the sleeve 22 limits the sleeve 22 to get near to the injector J. If there is no support nut 26, depending on the force applied to the pipe P, the sleeve 22 may be ejected from the nut 24 to be struck against the leading end of the injector J. In such a case, the leading end of the injector J is easily torn or cracked. However, according to the joint member 20 of this embodiment, such damage (tear or crack) can be prevented.

### <Modification>

Next, a modification of the joint member 20 according to the embodiment of the present disclosure will be described. A joint member 21 of this embodiment has the almost same configuration as the aforementioned joint member 20, except that the joint member 21 has a support nut 27 different from the support nut 26 of the joint member 20.

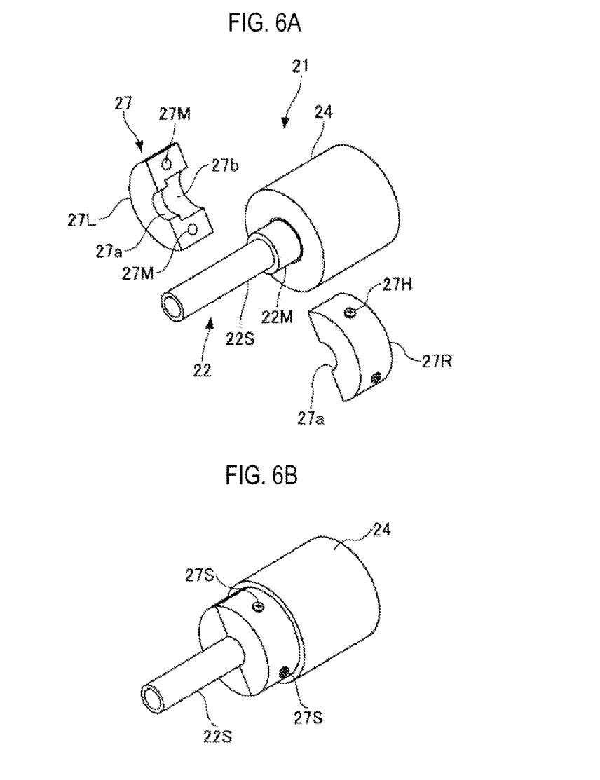

Referring to FIG. 6A, the joint member 21 is constituted by the nut 24, the sleeve 22, and the support nut 27. The support nut 27 includes two support members 27L and 27R (pressing members), which are coupled to each other and each have a C-shaped side shape. Each of the support members 27L and 27R has a groove 27a formed therein corresponding to the small diameter portion 22S of the sleeve 22 and has a groove 27b (a groove portion) formed therein corresponding to the medium diameter portion 22M of the sleeve 22. Also, thread holes 27M are respectively formed on two flat end surfaces of the support member 27L, and through-holes 27H corresponding to the thread holes 27M are formed in the support member 27R to extend perpendicular to two flat end surfaces thereof, respectively, by penetrating the support member 27R.

The support nut 27 is fixed to the sleeve 22 as shown in FIG. 6B by combining the support members 27L and 27R so that the grooves 27a receive the small diameter portion 22S and the grooves 27b receive the medium diameter portion 22M, inserting screws 27S (coupling members) (FIG. 6B) through the through-holes 27H, and tightening the screws 27S to the thread holes 27M. Accordingly, the support nut 27 can limit movement of the sleeve 22 relative to the nut 24 in a similar way to the support nut 26 described above. Thus, according to the joint member 21 of this modification, the same effect (advantage) as the aforementioned joint member 20 can be achieved.

In addition, a slight gap between the support nut 27 and the nut 24 is formed to the extent that the movement of the sleeve 22 relative to the nut 24 is limited. Thus, the support nut 27 does not obstruct the rotation (a twist) of the nut 24, which is the same as the aforementioned embodiment.

In the joint member 20, the support nut 26 needs to fit around the sleeve 22 before the pipe P is welded to the sleeve 22. However, according to the joint member 21 of the modification, the support nut 27 can be installed to the sleeve 22 after the nut 24 is installed to the injector support pipe 14A. Thus, according to the joint member 21 of the modification, there is an advantage in that the joint member 21 can be subsequently installed to an existing joint and the injector J can be prevented from being torn or cracked.

While the present disclosure has been described the preferable embodiment and the modification, the present disclosure is not limited to the aforementioned embodiments, but may be variously modified or altered within the scope of the present disclosure defined by the accompanying claims.

For example, a concave portion (or a convex portion) may be formed on the outer peripheral surface of the medium diameter portion 22M of the sleeve 22, and a convex portion (or a concave portion) corresponding to the concave portion (or the convex portion) may be formed on the inner peripheral surface of the support nuts 26 or 27. Accordingly, the support nut 26 can be installed to the sleeve 22 by inserting the convex portion of the support nut 26 into the concave portion of the medium diameter portion 22M of the sleeve 22. In this case, the support nut 26 is preferably made of a resin having pliability. In addition, the aforementioned concave portion may be a closed groove going around the outer peripheral surface of the small diameter portion 22S of the sleeve 22, and the convex porti on corresponding to the concave portion may be a closed protrusion going around the inner peripheral surface of the support nut 26. Further, a convex portion may be formed on the inner surface of the support nut 27 of the modification, the support nut 27 may be fixed to the sleeve 22 by inserting the convex portion into the concave portion of the medium diameter portion 22M.

In addition, instead of installing the support nut 26 to the small diameter portion 22S of the sleeve 22, the support nut 26 may be installed to the pipe welded to the sleeve 22. In this case, the support nut 26 preferably includes a first circular cylindrical portion having an inner diameter larger than the outer diameter of the medium diameter portion 22M of the sleeve 22 and a second circular cylindrical portion having a thread, which corresponds to a thread provided on the pipe, formed on an inner peripheral surface thereof. In such case, the first circular cylindrical portion covers the medium diameter portion 22M while a gap between the first circular cylindrical portion and the medium diameter portion 22M is formed.

Furthermore, although each of the support members 27L and 27R of the support nut 27 according to the modification has a C-shaped side shape, the shape is not limited thereto. Each of support members 27L and 27R may have, for example, a plate shape to the extent that they are securely installed to the sleeve 22. Also, in order to make the installation easy, one end of each of the support members 27L and 27R is provided with a hinge or the like, the other end may be allowed to be open and close. Further, although the thread holes 27M and the through-holes 27H are used to combine the support members 27L and 27R with the screws 27S, the support members 27L and 27R may be combined, for example, by attaching adhesive tapes or the like, to the outer peripheral surfaces of the support members 27L and 27R.

When the support nut 26 is installed to the medium diameter portion 22M of the sleeve by the thread coupling, the combination of the convex and concave portions, or the like, the support nut 26 is detachably installed to the sleeve 22. However, the present disclosure is not limited thereto, and the support nut may be welded to the medium diameter portion 22M of the sleeve 22. However, when the O-ring 34 shown in FIGS. 4A to 4D is stuck to the inclined end surface the large diameter portion 22L of the sleeve 22, if the large diameter portion 22L of the sleeve 22 can be allowed to protrude from the nut 24, the O-ring 34 can be easily detached from the inclined end surface. In this respect, the support nut 26 may be detachably installed to the sleeve 22.

Further, although in the aforementioned embodiment, the sleeve 22 has the large diameter portion 22L, the medium diameter portion 22M, and the small diameter portion 22S, the sleeve 22 may have only the large diameter portion 22L and the medium diameter portion 22M. A groove having an outer diameter smaller than the outer diameter of the medium diameter portion 22M may also be provided between the large diameter portion 22L and the medium diameter portion 22M.

Furthermore, although both the aforementioned support nuts 26 and 27 have a circular cylindrical shape (including an annular shape), the shape is not limited thereto. For example, as the support nut 26 is viewed from the side (as viewed along the central axis CA shown in FIG. 3A), the support nut 26 may have a polygonal cylindrical shape. In case of a polygonal cylindrical shape as viewed from the side, the outer surface thereof may have a concave and convex portion in an approximately cross shape or gear shape. Also, the outer peripheral surface of the medium diameter portion 22M of the sleeve 22 has one or more thread holes extending in a direction normal to the outer peripheral surface, and bolts corresponding to the thread holes may be used instead of the support nuts 26 and 27.

Moreover, it has been described in the aforementioned embodiments that the injector J made of quartz glass and the pipe P made of stainless steel are connected by the joint member 20. However, without limitation to quartz glass, even when a pipe, e.g., injector J, made of a more brittle material than that of the sleeve and a pipe made of a different material are connected to each other, the joint member 20 according to the embodiment of the present disclosure may be used.

In addition, the case using a vertical type substrate processing apparatus has been described in the aforementioned embodiments as an example. For example, the injector J is introduced into the inner tube 16 through the injector support pipe 14A installed to the outer wall of the manifold 14, which supports the inner tube 16 and the outer tube 18. However, for example, even when an injector made of quartz is introduced through a sidewall of a single type or semi-batch type chamber made of metal, the joint according to the embodiments of the present disclosure can be appropriately used.

The joint according to the embodiments of the present disclosure can also be appropriately applied to a substrate processing apparatus supplied with liquid, in addition to the substrate processing apparatus in which a gas is supplied from an injector into a reaction tube (or chamber) and substrates accommodated in the reaction tube (or chamber) are processed.

Although the spacer ring 32 is used in the aforementioned embodiments, the spacer ring 32 may not be used in other embodiments. In such a case, the O-ring 30 or 34 is interposed between the inclined end surface of the injector support pipe 14A and the inclined end surface of the large diameter portion 22L of the sleeve 22.

A ring-shaped spacer member may be disposed between the large diameter portion 22L of the sleeve 22 inside the nut 24 and the inner surface of the bottom 24B of the nut 24. In this case, the large diameter portion 22L indirectly contacts with the inner surface of the bottom 24B of the nut 24 through the spacer member. Accordingly, the movement of the sleeve 22 relative to the nut 24 is limited. Also, instead of the spacer member, a retainer including a bearing may be installed between the large diameter portion 22L of the sleeve and the inner surface of the bottom 24B of the nut.

According to the embodiments of the present disclosure, there are provided a joint member, a joint, a substrate processing apparatus, and a limit member preventing a leading end of an injector from being torn or cracked.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A joint member, comprising:
a cylindrical sleeve member having a first outer diameter portion having a first outer diameter and a second outer diameter portion having a second outer diameter smaller than the first outer diameter, both the first and second outer diameter portions arranged along a central axis of the cylindrical sleeve member;
a cylindrical nut member having an inner peripheral surface on which a first thread is formed and a bottom in which an opening is formed, an inner diameter of the inner peripheral surface is larger than the first outer diameter, and a diameter of the opening is smaller than the first outer diameter and larger than the second outer diameter; and
a limit member fixed to an outer periphery portion of the second outer diameter portion which is inserted into the opening and is in contact with an outer surface of the bottom of the cylindrical nut member, and the first outer diameter portion is in contact with an inner surface of the bottom of the cylindrical nut member, the limit member limiting movement of the cylindrical sleeve member relative to the cylindrical nut member in the direction of the central axis.

2. The joint member of claim 1, wherein the limit member has a cylindrical shape and includes an inner peripheral surface, on which a second thread is formed, and
wherein the second outer diameter portion of the cylindrical sleeve member has an outer peripheral surface, on which a third thread corresponding to the second thread is formed.

3. The joint member of claim 2, wherein the limit member has a circular cylindrical shape or a polygonal cylindrical shape.

4. The joint member of claim 1, wherein the limit member comprises:
a plurality of pressing members pressing the second outer diameter portion of the cylindrical sleeve member; and
a coupling member coupling the plurality of pressing members to each other.

5. The joint member of claim 4, wherein the pressing members include a groove portion receiving a part of the second outer diameter portion to press the part of the second outer diameter portion.

6. A joint, comprising:
the joint member according to claims 1; and
a circular cylindrical male screw portion having an outer peripheral surface on a leading end of which a fourth thread corresponding to the first thread is formed.

7. A substrate processing apparatus, comprising:
the joint according to claim 6; and
a chamber made of metal, the circular cylindrical male screw portion being installed to the chamber.

8. The substrate processing apparatus of claim 7, further comprising a pipe inserted into the circular cylindrical male screw portion.

9. The substrate processing apparatus of claim 8, wherein the pipe is made of a material more brittle than that of the cylindrical sleeve member.

10. The substrate processing apparatus of claim 8, further comprising a circular cylindrical tube into which the pipe is inserted and, the circular cylindrical tube connecting the male screw portion to the chamber.

11. A limit member comprising:
a fixing portion fixed to an outer periphery portion of a second outer diameter portion of a cylindrical sleeve member which is inserted into an opening formed in a bottom of a cylindrical nut member;
wherein the cylindrical sleeve member has a first outer diameter portion having a first outer diameter and the second outer diameter portion having a second outer diameter smaller than the first outer diameter, and the first and second outer diameter portions are arranged along a central axis of the cylindrical sleeve member and a through-hole formed along the central axis in the first and second outer diameter portions, and
wherein the cylindrical nut member has an inner peripheral surface on which a first thread is formed and a bottom in which an opening is formed, and an inner diameter of the inner peripheral surface is larger than the first outer diameter, and a diameter of the opening is smaller than the first outer diameter and larger than the second outer diameter, and
wherein, when the cylindrical sleeve member is inserted into the opening formed in the bottom of the cylindrical nut member, the limit member is in contact with an outer surface of the bottom of the cylindrical nut member, and the first outer diameter portion is in contact with an inner surface of the bottom of the cylindrical nut member, the limit member limiting movement of the cylindrical sleeve member relative to the cylindrical nut member in a direction of the central axis.

12. The limit member of claim 11, wherein the limit member has a cylindrical shape having an inner peripheral surface on which a second thread is formed, and the second thread corresponding to a third thread is formed on an outer peripheral surface of the second outer diameter portion.

13. The limit member of claim 11, wherein the limit member has a circular cylindrical shape or a polygonal cylindrical shape.

14. The limit member of claim 11, comprising:
a plurality of pressing members pressing the second outer diameter portion of the cylindrical sleeve member; and
a coupling member coupling the plurality of pressing members to each other.

15. The limit member of claim 14, wherein the pressing members includes a groove portion receiving a part of the second outer diameter portion to press the part of the second outer diameter portion.
